(19) United States
(12) Patent Application Publication
(10) Pub. No.: US 2011/0287688 A1
(43) Pub. Date: Nov. 24, 2011

(54) ELECTRONIC TOY AND WATERPROOF MODULAR DESIGN

(76) Inventors: Raymond Mok Chi Hang, Tsing Yi (HK); QiFang Xia, Guang Dong (CN)

(21) Appl. No.: 12/782,192

(22) Filed: May 18, 2010

(51) Int. Cl. A63H 33/00; B23P 17/04; A63H 29/22

(52) U.S. Cl. 446/153; 446/484; 29/592.1

(57) ABSTRACT

The present disclosure is directed to an electronic water toy and techniques to protect electrical components of the toy from water. The toy may include a plurality of waterproof electronics modules, a non waterproof outer housing, and a plurality of insulated wires. Each waterproof electronics module may include an electrical component, and a waterproof compartment to house the electrical component and to protect the electrical component from water. The non waterproof outer housing may physically interconnect the plurality of waterproof electronics modules. The waterproof compartment may include counterbore through holes to permit wires through the waterproof compartment and a counterbore leak test port to permit pressure testing of the waterproof compartment.

### FIELD OF THE INVENTION

The present invention relates generally to electronic toys, and more specifically to electronic water toys and techniques to protect electrical components from water.

### BACKGROUND OF THE INVENTION

Electronic water toys are required to be waterproof to preventing water from entering the toy and short circuiting electrical components. One technique for waterproofing electronic toys is to waterproof the outer housing of the toy. In such a technique, a gasket is typically placed between an upper housing component and lower housing component. Screws or other fastening mechanisms cause the upper housing component to exert force upon the lower housing component. Such force compresses and deforms the gasket thus causing the gasket to seal the interface or seam between the two housing components.

With the above described technique, however, the quality of the seal is highly reliant upon the upper and lower housing components having very closely matched surfaces and contours in order to exert the compression force evenly on the gasket. Due to the length and number of seams, manufacturing outer housing components with closely matched surfaces and contours proves to be costly.

### BRIEF SUMMARY OF THE INVENTION

The present disclosure is directed to electronic water toys and techniques to protect electrical components of such electronic water toys from water or other liquids.

According to one aspect, an electronic water toy is provided. The electronic water toy may include a plurality of waterproof electronics modules, a non waterproof outer housing, and a plurality of insulated wires. Each waterproof electronics module may include an electrical component, and a waterproof compartment to house the electrical component and to protect the electrical component from water. The non waterproof outer housing may physically interconnect the plurality of waterproof electronics modules, and the plurality of insulated wires may pass through the waterproof compartments and electrically interconnect the electrical components housed in the waterproof compartments.

According to another aspect, each waterproof compartment may include a leak test port in an outer wall of the waterproof compartment to permit leak testing of the waterproof compartment. The leak test port may include a hole and a counterbore. The leak test port may be plugged after testing to prevent water from entering the waterproof compartment during use of the water toy. Furthermore, the leak test port may be plugged with a fastener (e.g., a screw) and sealant (e.g., glue). The fastener may be inserted into the hole of the leak test port. The sealant may be deposited over the screw such that the sealant at least partially fills the counterbore.

According to another aspect, each waterproof compartment may include one or more through holes and corresponding counterbores in a wall of the waterproof compartment. Each through hole may have an insulated wire of the plurality of insulated wires that passes therethrough to electrically connect to electrical components in the waterproof compartment. A sealant may at least partially fill the corresponding counterbore of the through hole and prevent water from entering the waterproof compartment via the through hole.

Per yet another aspect, the waterproof modules may include one or more waterproof controller modules, one or more waterproof output modules such as waterproof speaker module and/or a waterproof light module, one or more waterproof input modules such as a waterproof button module, and/or one or more waterproof power modules such as a waterproof battery module. The waterproof controller module may include a processor such as a microprocessor, microcontroller, programmable array, and/or other logic component. The waterproof controller module may process electrical signals received from other waterproof modules via at least one insulated wire. The waterproof controller module may also provide electrical control signals to other waterproof modules via at least one insulated wire to control operation of such waterproof modules.

The waterproof speaker module may includes a waterproof speaker. The waterproof speaker may produce sound in response to electrical signals received via at least one insulated wire of the plurality of insulated wires.

The waterproof light module may include a light emitting device such as a light emitting diode (LED). The light emitting device may emit light in response to electrical signals received via at least one insulated wire of the plurality of insulated wires.

The waterproof input module may include an input device such as a pressure switch or button. The input device may receive input and provide electrical signals that are indicative of the received input to another waterproof module via at least one insulated wire of the plurality of insulated wires.

The waterproof power module may include a power source such as a battery. The power source may provide electrical power to another waterproof module via at least one insulated wire of the plurality of insulated wires.

### BRIEF DESCRIPTION OF SEVERAL VIEWS OF THE DRAWINGS

Embodiments are described herein by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements in the figures.

FIG. 1 shows an embodiment of an electronic water toy that includes waterproof electronics modules.

FIG. 2 shows a block diagram depicting one manner by which waterproof electronics modules may be electrically connected.

FIG. 3 shows an embodiment a waterproof input module.

FIG. 4 shows an embodiment a waterproof speaker module.

FIG. 5 shows an embodiment of a waterproof controller/power module.

FIG. 6 shows an embodiment of a waterproof light module.

FIG. 7A shows an embodiment of wire through holes and an embodiment of a leak test port.

FIG. 7B shows an embodiment of a plugged leak test port.

FIG. 8A shows an interface between housing components prior to being ultrasonic welded to one another.

FIG. 8B shows an interface between housing components after being ultrasonic welded to one another.

### DETAILED DESCRIPTION OF THE INVENTION

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, a particular feature, structure, or characteristic described in connection with an embodiment generally may be incorporated into or otherwise implemented by other embodiments regardless of whether explicitly described.

Referring now to FIG. 1, there is depicted an embodiment of an electronic water toy 100 that may be suitable for play in a bath tub, wading pool, and/or other water environments. As shown, the water toy 100 may include an outer housing 110 having one or more outer housing components that define an outer shape of the water toy 100. For example, the outer housing 110 may include outer housing components that define arms 112, 114, legs, 116, 118, body 120, and head 122.

Despite the fact the water toy 100 includes electrical components; the outer housing 110 in one embodiment is not waterproof. Due to the size and number of moving components comprising the outer housing, manufacturing the outer housing 110 to be waterproof would be costly. Thus, in one embodiment, electrical components of the water toy 100 are housed in several smaller waterproof modules that are distributed throughout the outer housing 110. Accordingly, the outer housing 110 in one embodiment does not protect electronic components from water. Instead, the outer housing 110 defines an outer shape of the water toy 110, mechanically interacts with the waterproof electrical components, and mechanically interconnects the waterproof electrical components.

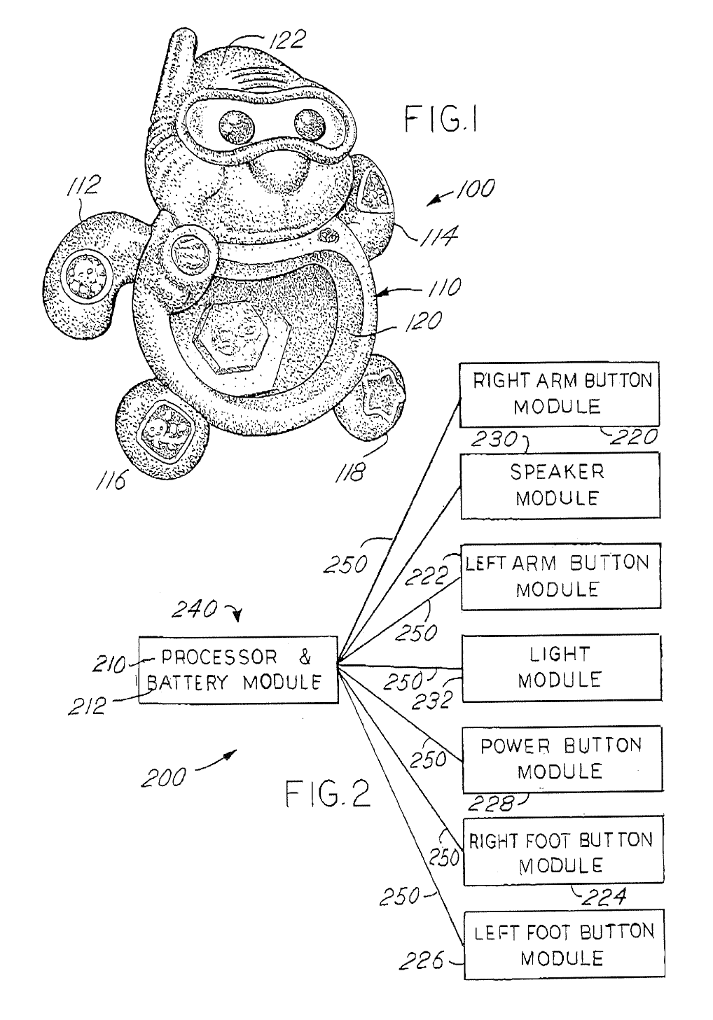

As shown in FIG. 2, the water toy 100 may include a system 200 of waterproof electronics modules. In particular, the water toy 100 may include waterproof controller modules 210, waterproof power modules 212, waterproof input modules 220, 222, 224, 226, 228, waterproof output modules 230, 232, and/or waterproof hybrid modules that provide the functionality of one or more of the basic waterproof electronics modules. For example, the water toy 200 may include a waterproof hybrid module 240 which integrates the functions of a controller module 210 and a power module 212 into a single waterproof module.

As shown, the system 200 may further include insulated wires 250 that electrically couple electronic components of one waterproof electronics module to another waterproof electronics module. In one embodiment, the components are electrically connected in a hub and spoke manner in which the hybrid processor/power module 240 is the hub and the insulated wires 250 are spokes connecting the hybrid processor/power module 240 to each of the other waterproof electronic components 220, 222, 224, 226, 228, 230, 232. However, depending upon the communication needs of the electrical components, the insulated wires 250 may implement other interconnection topologies such as mesh, ring, etc. in order to provide appropriate electrical interfaces between the various electrical components of the waterproof electronics modules.

FIG. 2 further illustrates the distributed nature of the waterproof electronics modules. For example, a processor/battery module 240 and a speaker module 230 may be positioned in a head portion 122 of the outer housing 110. A right arm button module 220, a left arm button module 222, a right leg button module 224, and a left leg button module 226 may be respectively positioned in a right arm portion 112, a left arm portion 114, a right leg portion 116, and a left leg portion 118 of the outer housing 110. Moreover, a light module 232 and a power button module 228 may be positioned in a body portion 120 of the outer housing 110.

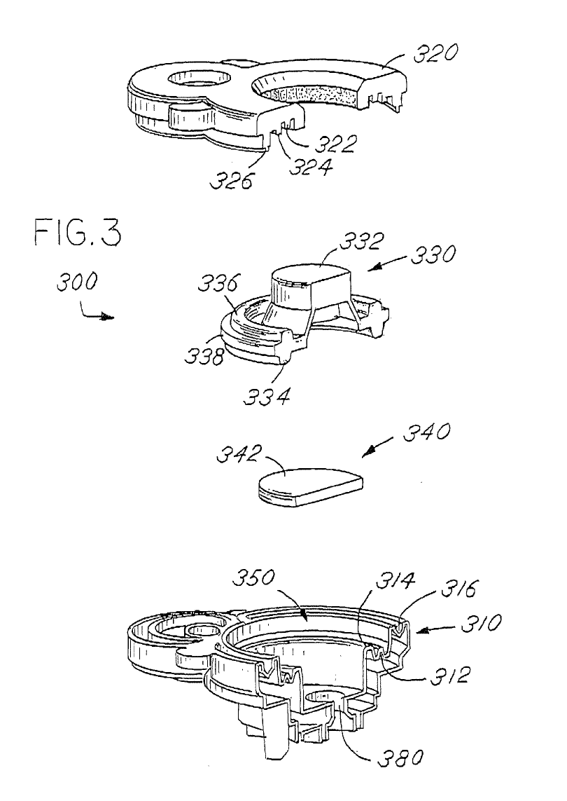

Referring now to FIG. 3, further details of a button module embodiment 300 of a waterproof input module are shown. In particular, the button module 300 shown in FIG. 3 may be suitable for implementing the input modules 220, 222, 224, 226, 228 of FIG. 2. As shown, the button module 300 includes a lower cabinet member 310, an upper cabinet member 320, a button 330, and a printed circuit board 340 comprising one or more electrical component(s) 342.

In one embodiment, the button 330 performs a dual function. First, the button 330 is configured to transfer force applied to an upper surface 332 of the button 330 to a pressure switch, capacitive switch, or some other sensor component of the electrical components 342. As a result of such transfer of force, the electrical components 342 may detect input (e.g., a user pressing the button) and may generate electrical signals that are indicative of the received input. In one embodiment, one or more insulated wires 250 carry such electrical signals to the controller module 240 for processing.

The button 330 also serves as a gasket to help seal the interface or seam between the lower cabinet member 310 and the upper cabinet member 320. To such an end, a lower surface of the button 330 includes a lower annular rib 334, and an upper surface of the lower cabinet member 310 includes an annular groove 312 to receive the lower annular rib 334. Similarly, an upper surface of the button 330 includes an upper annular rib 336, and a lower surface of the upper cabinet member 320 includes an annular groove 322 to receive the upper annular rib 336. Furthermore, the button 330 includes an annular lip 338 that extends radially beyond the location of the lower and upper annular ribs 334, 336. The lower cabinet member 310 includes an annular seat 314, and the upper cabinet member 320 includes an annular seat 324. The annular seats 314, 324 are configured to compress and deform the annular lip 338 when the ribs 334, 336 are respectively received by the grooves 312, 322 and the upper cabinet member 320 is affixed to the lower cabinet member 310.

In one embodiment, the lower and upper cabinet members 310, 320 are affixed to one another through an ultrasonic welding process. To this end, a lower surface of the upper cabinet member 322 includes an annular rib 326. Furthermore, an upper surface of the lower cabinet member 310 includes another annular groove 316 positioned radially outward from the other annular groove 312 and configured to receive the annular rib 326 of the upper cabinet member. The engagement of the annular rib 326 and the annular groove 316 prior to welding is shown in greater detail in FIG. 8A. As shown, a gap 360 exists between the surface of the rib 326 and the surface of the groove 316. However, as shown in FIG. 8B, the ultrasonic welding processes deforms the rib 326 such that afterwards the gap 360 is eliminated, and the upper cabinet member 320 is fused to the lower cabinet member 310. Thus, when assembled, the lower cabinet member 310, upper cabinet member 320, and button 330 define a waterproof compartment 350 to house and protect the electrical components 340

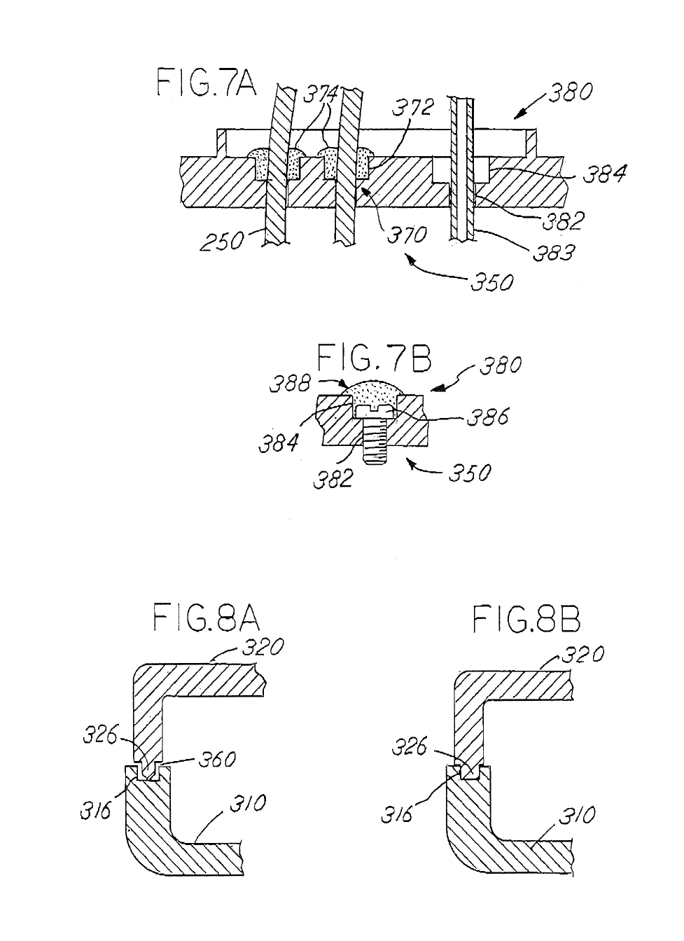

As shown in greater detail in FIG. 7A, the button module 300 may further comprise one or more though holes 370 in one or more walls of the waterproof compartment 350. The through holes 370 permit the passage of insulated wires 250 through the walls of the waterproof compartment 350 to the electrical components 342, and thus permit electrically coupling the electrical components 342 to electrical components external to the waterproof compartment 350.

As shown, each through hole 370 has a corresponding counterbore 372. To prevent leaks, a sealant 374 such as glue is used to partially fill, fill, or overfill the counterbore 372 thus providing a waterproof seal between the insulated wire 250 passing through the hole 370 and the waterproof compartment 350. In one embodiment, the diameter of the each through hole 370 is just large enough to accommodate the wire 250 passing through it. The corresponding counterbore 372 however has a greater diameter than its corresponding through hole 370. The larger diameter of the counterbore 372 generally improves the efficacy of the seal between the wire 250 and the compartment 350 because it increases the surface area over which the sealant may affix.

Moreover, the button module 300 may include a leak test port 380 through which a capillary tube 383 may pass in order to pressure test the button module 300 for leaks after assembly. Similar to the through holes 370, the leak test port 380 may include a hole 382 and a counterbore 384 having a larger diameter than the hole 382. As shown in FIG. 7B, the capillary tube 383 may be removed from the leak test port 380 after leak testing. A plug 386 such as a fastener or screw may be inserted into the hole 382 of the leak test port 380 to plug the hole and maintain the waterproof nature of the compartment 350. Moreover, sealant 388 such as glue may partially fill, fill, or overfill the counterbore 384. The counterbore 384 generally improves the efficacy of the seal between the plug 386 and the compartment 350 because counterbore 384 increases the surface area over which the sealant may affix.

The waterproof electronics modules may be pre assembled and sealants permitted to cure prior to final test and assembly. After curing, the external end of the capillary tube 383 may be attached to a pressure management device. The pressure management device may pump gas into the waterproof compartment 350. The pressure management device may then monitor the internal pressure of the waterproof compartment 350. If the waterproof compartment 350 is properly sealed, then there should be little change in the internal pressure. If the module passes the pressure test, then the leak test port 380 may be plugged with a fastener 386 and sealant 388 as described above.

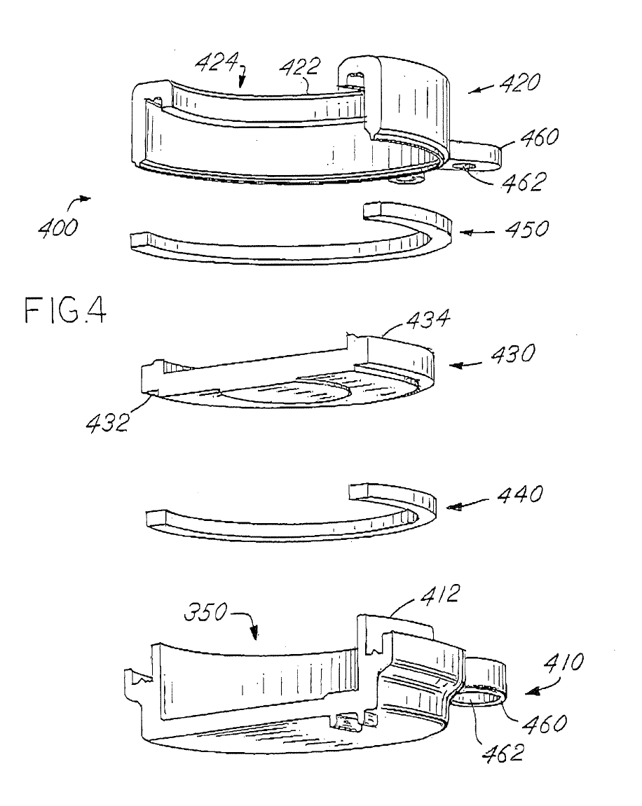

Referring now to FIG. 4, further details of a speaker module embodiment 400 of a waterproof output module are shown. In particular, the speaker module 400 shown in FIG. 4 may be suitable for implementing the output module 230 of FIG. 2. As shown, the speaker module 400 includes a lower cabinet member 410, an upper cabinet member 420, a waterproof speaker 430 comprising one or more electrical component(s) 432, a lower gasket 440, and an upper gasket 450. In general, the waterproof speaker 430 produces sound in response to electrical signals received via one or more insulated wires 250.

The lower gasket 440 helps seal the interface or seam between the lower cabinet member 410 and the speaker 430. To such an end, an upper surface of the lower cabinet member 410 includes an annular edge 412 configured to engage the lower gasket 440, and a lower surface of the speaker 430 includes an annular groove 432 to configured to receive lower gasket 440. The annular edge 412 and the annular groove 432 are configured to compress and deform the lower gasket 440 in order to seal the interface between the lower cabinet member 410 and the speaker 430 when the upper cabinet member 420 is affixed to the lower cabinet member 410.

Similarly, the upper gasket 450 helps seal the interface or seam between the upper cabinet member 420 and the speaker 430. To such an end, an upper surface of the speaker 430 includes an annular edge 434 configured to engage the upper gasket 450, and a lower surface of the upper cabinet member 420 includes an annular groove 422 configured to receive the upper gasket 450. The annular edge 434 and the annular groove 422 are configured to compress and deform the upper gasket 450 in order to seal the interface between the upper cabinet member 420 and the speaker 430 when the upper cabinet member 420 is affixed to the lower cabinet member 410.

As shown, the upper cabinet member 420 may further include an aperture 424 in an upper surface which exposes the upper surface of the speaker 434 to the external environment. The aperture 424 may improve sound quality of the speaker 434 by not placing an additional dampening surface between the speaker 434 and the listener.

As the speaker 430 is a frequency response unit and produces tiny axial movement of cone paper, the cabinet members 410, 420 in one embodiment are fastened together via screws and not joined via ultrasonic welding process. To such end, the cabinet members 410, 420 include one or more flange members 460 have holes 462 to permit affixing the cabinet member 410, 420 to one another via screws and/or other types of fasteners. When assembled, the cabinet members 410, 420 and speaker 430 form a waterproof compartment 350 primarily between the lower surface of the speaker 430 and the upper surface of the lower cabinet member 410.

In a manner similar to the button module 300, the lower cabinet member 410 may include one or more through holes 370, a leak test port 380, and a capillary tube 383 as shown in FIG. 7A. Insulated wires 250 may pass through the through holes 370 and attach to speaker terminals on the lower side of the speaker 430. Sealant 374 may fill counterbores 372 to prevent leaks via the through holes 370. Moreover, sealant 388 and a fastener 386 may plug the leak test port 380 after testing as shown in FIG. 7B.

Referring now to FIG. 5, further details of a hybrid controller/power module embodiment 500 are shown. In particular, the controller/power module 500 shown in FIG. 5 may be suitable for implementing the controller module 210 and the power module 212 of FIG. 2. As shown, the controller/power module 500 includes a lower cabinet member 510, an upper cabinet member 520, a battery cabinet member 530, a printed circuit board 540 comprising electrical component(s) 542, and a two way gasket 550.

In general, the hybrid controller/power module 500 provides the functionality of a controller module and a power module. As a power module, the module 500 may include a power source such as a battery. The power source may provide electrical power to other waterproof modules via the insulated wires 250.

As a controller module, the module 500 may include electrical components 542 such as a processor, microprocessor, microcontroller, programmable array, and/or other logic components. Such electrical components may receive electrical signals via the insulated wires 250, and process electrical signals received from other waterproof modules. The electrical components may also provide electrical control signals to other waterproof modules via insulated wires 250 to control operation of such waterproof modules.

The battery cabinet member 530 includes wells 532 configured to receive a portable power source such as batteries. The battery cabinet member 530 further includes an annular flange 534 toward an upper end of the battery cabinet member 530. The two way gasket 550 includes an annular groove 552 in an inner surface that is configured to receive the annular flange 534. Moreover, the lower cabinet member 510 includes an annular ledge 512 that is configured to receive the a lower surface of the two way gasket 550 after the flange 534 has been placed in the groove 552. The lower cabinet member 510, the battery cabinet member 530 and two gasket 550 are configured to form a waterproof compartment 350 when the gasket covered flange 534 rests upon the ledge 512.

As shown, the upper cabinet member 520 provides a hinged door that may be actuated to obtain access to the wells 532 of the battery cabinet member 530. Moreover, a lower surface of the upper cabinet member 520 includes an annular ridge 522 that is configured to engage an upper surface of the two way gasket 550. Furthermore, the upper cabinet member 520 includes holes 524 positioned outside the perimeter of the annular ridge 522. The lower cabinet member 510 includes threaded holes 514 which correspond to the holes 524 of the upper cabinet member 520. When the hinged door is closed, fasteners such as screws may be threaded through the holes 514, 524 and tightened. Such tightening causes the annular ridge 522 to compress and deform the two way gasket 550 and to form a waterproof seal between upper cabinet member 520 and the battery cabinet member 530. As such, once assembled, the controller/power module 500 has two waterproof compartments 350. One above the battery cabinet member 530 to house the power source and one below the battery cabinet member 530 to house the controller.

In a manner similar to the button module 300, the lower cabinet member 510 may include one or more through holes 370, a leak test port 380, and a capillary tube 383 as shown in FIG. 7A. Insulated wires 250 may pass through the through holes 370 and attach to the printed circuit board 540. Sealant 374 may fill counterbores 372 to prevent leaks via the through holes 370. Moreover, sealant 388 and a fastener 386 may plug the leak test port 380 after testing as shown in FIG. 7B.

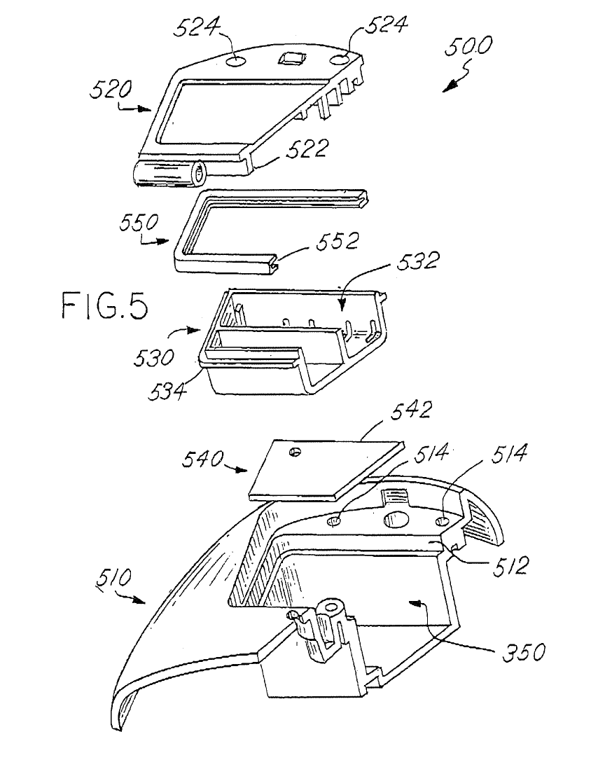

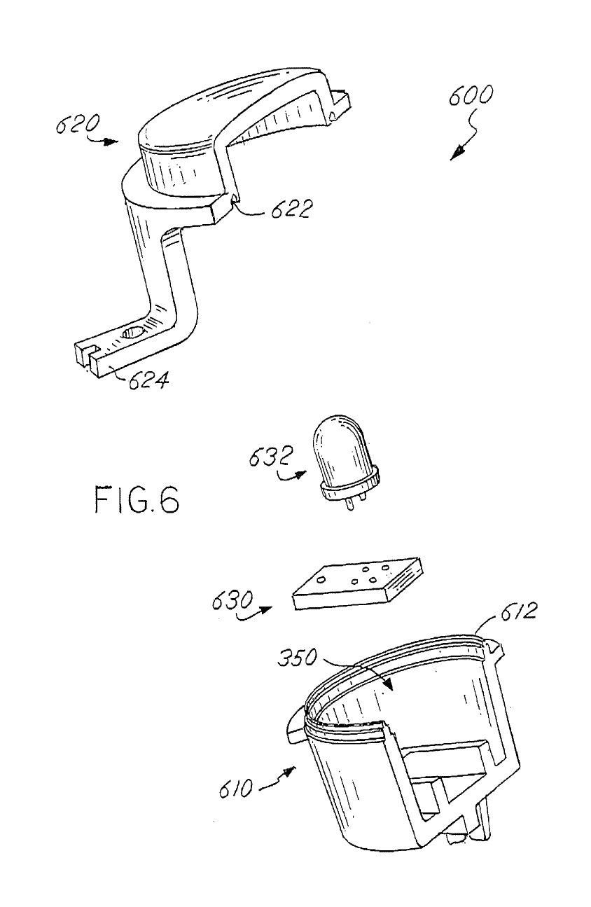

Referring now to FIG. 6, further details of a light module embodiment 600 of an waterproof output module are shown. In particular, the light module 600 shown in FIG. 6 may be suitable for implementing the output module 232 of FIG. 2. As shown, the light module 600 includes a lower cabinet member 610, an upper cabinet member 620, a printed circuit board 630 comprising one or more electrical component(s) 632 such as a light emitting diode (LED) or other light emitting device. In general, the light emitting device may emit light in response to electrical signals received via the insulated wires 250.

The upper cabinet member 620 in one embodiment is formed from a translucent material to permit an external viewer such as a toddler to perceive light from the LED 632. Moreover, the upper cabinet member 620 may include one or more flanges 624 which permit fastening the light module 600 to another object such as the outer housing 110 of the water toy 100.

In one embodiment, the lower and upper cabinet members 610, 620 are affixed to one another through an ultrasonic welding process. To this end, an upper end of the lower cabinet member 610 includes an annular rib 612. Furthermore, a lower surface of the upper cabinet member 620 includes an annular groove 622 configured to receive the annular rib 612 of the lower cabinet member 610. As described above in regard to FIGS. 8A, 8B, the ultrasonic welding process elements a gap between surfaces of the rib 612 and groove 622 and results in the cabinet members 610, 612 being fused together to form a waterproof cabinet 350.

In a manner similar to the button module 300, the lower cabinet member 610 may include one or more through holes 370, a leak test port 380, and a capillary tube 383 as shown in FIG. 7A. Insulated wires 250 may pass through the through holes 370 and attach to the printed circuit board 630. Sealant 374 may fill counterbores 372 to prevent leaks via the through holes 370. Moreover, sealant 388 and a fastener 386 may plug the leak test port 380 after testing as shown in FIG. 7B.

Many modifications and variations of the disclosed embodiments are possible in light of the above teachings. Thus, it is to be understood that, within the scope of the appended claims, aspects of the disclosed embodiments may be practiced in a manner other than as described above.

What is claimed is:

1. An electronic water toy, comprising:
a plurality of waterproof electronics modules, each waterproof electronics module including:
an electrical component; and,
a waterproof compartment to house the electrical component and protect the electrical component from water;
a non waterproof outer housing to physically interconnect the plurality of waterproof electronics modules; and,
a plurality of insulated wires that pass through the waterproof compartments and that electrically interconnect the electrical components housed in the waterproof compartments.

2. The electronic water toy of claim 1, wherein each waterproof compartment comprises a leak test port in an outer wall of the waterproof compartment to permit leak testing of the waterproof compartment.

3. The electronic water toy of claim 2, wherein the leak test port comprises a hole and a counterbore that are plugged to prevent water from entering the waterproof compartment during use.

4. The electronic water toy of claim 3, wherein the leak test port is plugged with:
a fastener that is inserted into the hole of the leak test port; and
a sealant that is deposited over the fastener such that the sealant at least partially fills the counterbore.

5. The electronic water toy of claim 1, wherein each waterproof compartment comprises:
a through hole and corresponding counterbore in a wall of the waterproof compartment and through which an insulated wire of the plurality of insulated wires passes; and,
a sealant that at least partially fills the corresponding counterbore of the through hole and prevents water from entering the waterproof compartment via the through hole.

6. The electronic water toy of claim 1, wherein the plurality of waterproof modules comprises at least one waterproof controller module in which the electrical component includes a processor to process electrical signals received from other waterproof modules via at least one insulated wire of the plurality of insulated wires.

7. The electronic water toy of claim 1, wherein the plurality of waterproof modules comprises at least one waterproof controller module in which the electrical component includes a processor to provide electrical control signals to other waterproof modules via at least one insulated wire of the plurality of insulated wires.

8. The electronic water toy of claim 7, wherein the plurality of waterproof modules comprises at least one waterproof speaker module in which the electrical component includes a waterproof speaker to produce sound in response to electrical signals received via at least one insulated wire of the plurality of insulated wires.

9. The electronic water toy of claim 7, wherein the plurality of waterproof modules comprises at least one waterproof light module in which the electrical component includes a light emitting device configured to emit light in response to electrical signals received via at least one insulated wire of the plurality of insulated wires.

10. The electronic water toy of claim 6, wherein the plurality of waterproof modules comprises at least one waterproof input module in which the electrical component includes an input device configured to provide electrical signals that are indicative of received input to another waterproof module via at least one insulated wire of the plurality of insulated wires.

11. The electronic water toy of claim 1, wherein the plurality of waterproof modules comprises at least one waterproof power module in which the electrical component includes a power source configured to provide electrical power to another waterproof module via at least one insulated wire of the plurality of insulated wires.

12. A method of waterproofing an electronic toy, comprising:
placing electrical components in a plurality of waterproof compartments;
passing wires through counterbore through holes in the plurality of waterproof compartments to electrical couple electrical components in the plurality of waterproof compartments;
depositing sealant in the counterbore through holes to prevent water from passing through the counterbore through holes; and,
distributing the plurality of water proof compartments throughout a non-waterproof outer housing of the electronic toy.

13. The method of claim 12, further comprising:
pumping gas into each waterproof compartment via a leak test port of each waterproof compartment;
determining whether each waterproof compartment has a leak based upon its ability to maintain the gas at pressure; and,
plugging the leak test port of each waterproof compartment in response to determining it has no leak.

14. The method of claim 13, wherein plugging the leak test port comprises
placing a fastener in a hole of the leak test port; and,
depositing sealant over the fastener and into a counterbore of the leak test port.
